(19) United States
(12) Patent Application Publication
(10) Pub. No.: US 2024/0203037 A1
(43) Pub. Date: Jun. 20, 2024

(54) MEDICAL IMAGE PROCESSING APPARATUS, MEDICAL IMAGE PROCESSING METHOD, AND RECORDING MEDIUM

(71) Applicants: KYOTO UNIVERSITY, Kyoto-shi (JP); Canon Kabushiki Kaisha, Tokyo (JP); CANON MEDICAL SYSTEMS CORPORATION, Tochigi (JP)

(72) Inventors: Ryo SAKAMOTO, Kyoto-shi (JP); Masahiro YAKAMI, Kyoto-shi (JP); Takeshi KUBO, Kyoto-shi (JP); Kiyohide SATOH, Kawasaki (JP); Yoshio IIZUKA, Yokohama (JP)

(73) Assignees: KYOTO UNIVERSITY, Kyoto-shi (JP); Canon Kabushiki Kaisha, Tokyo (JP); CANON MEDICAL SYSTEMS CORPORATION, Tochigi (JP)

(21) Appl. No.: 18/538,051

(22) Filed: Dec. 13, 2023

(30) Foreign Application Priority Data
Dec. 15, 2022 (JP) 2022-200427

(51) Int. Cl. G06T 15/08; G06T 11/00

(52) U.S. Cl. CPC G06T 15/08; G06T 11/00; G06T 2200/24; G06T 2211/40

(57) ABSTRACT

A medical image processing apparatus according to the present embodiment includes processing circuitry. The processing circuitry receives an instruction to move a slice position when a three-dimensional medical image including a plurality of slice images of a subject is displayed. The processing circuitry controls a display to display a slice image at a destination slice position as a first image when the received instruction is an instruction to move the slice position by less than a predetermined interval, and controls the display to display a second image reflecting information on a plurality of slice images including the slice image at the destination slice position when the received instruction is an instruction to move the slice position by more than the predetermined interval.

### CROSS-REFERENCE TO RELATED APPLICATIONS

This application is based upon and claims the benefit of priority from Japanese Patent Application No. 2022-200427, filed on Dec. 15, 2022; the entire contents of which are incorporated herein by reference.

### FIELD

Embodiments described herein relate generally to a medical image processing apparatus, a medical image processing method, and a recording medium.

### BACKGROUND

A medical imaging diagnostic apparatus, for example, takes an image of a subject to generate a three-dimensional medical image including a plurality of slice images of the subject. For example, a physician (or “diagnostic imaging physician” or “radiologist”), who is a user, uses three-dimensional medical images for radiologic interpretations. The user often observes a three-dimensional medical image including a plurality of slice images such as computed tomography (CT) images and magnetic resonance imaging (MRI) images in diagnostic imaging. When the user observes a three-dimensional medical image, the user acquires arbitrary slice images included in the three-dimensional medical image by using a medical image display device, and controls a display to display the acquired slice images. Usually, when the user gives an instruction to change the positions of the slice images in the three-dimensional medical image (hereinafter, referred to as “slice positions”) as per the order of the slice images or in reverse order, the medical image display device sequentially acquires the slice images to be displayed on the display. Hereafter, moving the slice position by +1 is referred to as +1 slice feeding, moving the slice position by −1 is referred to as −1 slice feeding, and +1 slice feeding and −1 slice feeding are collectively referred to as ±1 slice feeding. For example, when the user gives an instruction for ±1 slice feeding to a medical image processing apparatus, the medical image display device changes each slice image included in the three-dimensional medical image to be displayed on the display in the same or reverse order of its sequence.

An instruction given by the user who wants to quickly observe the entire three-dimensional medical image may result in an instruction for slice feeding while skipping (thinning out) the slice positions of the slice images displayed on the display by regular intervals (referred to as n). Here, n is a predetermined integer of 2 or more. Hereafter, moving the slice position by +n is referred to as +n slice feeding, moving the slice position by −n is referred to as −n slice feeding, and +n slice feeding and −n slice feeding are collectively referred to as ±n slice feeding. For example, when the user inputs an instruction for +1 slice feeding in order to quickly observe the three-dimensional medical image, the display process of the medical image display device may not be completed in time, resulting in +n slice feeding. In such a case, since the medical image processing apparatus displays the acquired slice images on the display while skipping slice positions at regular intervals, the slice images at the skipped slice positions are not displayed on the display.

### BRIEF DESCRIPTION OF THE DRAWINGS

FIG. 1 is a diagram illustrating an example of a configuration of a medical image processing system including a medical image processing apparatus according to a first embodiment;

FIG. 2 is a diagram illustrating an example of a configuration of the medical image processing apparatus according to the first embodiment;

FIG. 3 is a flowchart illustrating the procedure of a process performed by the medical image processing apparatus according to the first embodiment;

FIG. 4A is a diagram illustrating a specific example of a user operation at step S101 in FIG. 3 as a process performed by the medical image processing apparatus according to the first embodiment;

FIG. 4B is a diagram illustrating another specific example of the user operation at step S101 in FIG. 3 as a process performed by the medical image processing apparatus according to the first embodiment;

FIG. 5A is a diagram illustrating a display example when steps S103 to S105 in FIG. 3 are performed as a process performed by the medical image processing apparatus according to the first embodiment;

FIG. 5B is a diagram illustrating a display example when steps S106 to S108 in FIG. 3 are performed as a process performed by the medical image processing apparatus according to the first embodiment;

FIG. 6A is a diagram illustrating a first configuration example of a slab image as a process performed by the medical image processing apparatus according to the first embodiment;

FIG. 6B is a diagram illustrating a second configuration example of a slab image as a process performed by the medical image processing apparatus according to the first embodiment;

FIG. 6C is a diagram illustrating a third configuration example of a slab image as a process performed by the medical image processing apparatus according to the first embodiment;

FIG. 6D is a diagram illustrating a fourth configuration example of a slab image as a process performed by the medical image processing apparatus according to the first embodiment;

FIG. 6E is a diagram illustrating a fifth configuration example of a slab image as a process performed by the medical image processing apparatus according to the first embodiment;

FIG. 7 is a diagram illustrating another display example of a process performed by the medical image processing apparatus according to the first embodiment;

FIG. 8 is a flowchart illustrating the procedure of a process performed by a medical image processing apparatus according to a second embodiment;

FIG. 9 is a diagram illustrating another display example of a process performed by the medical image processing apparatus according to the second embodiment;

FIG. 10 is a flowchart illustrating the procedure of a process performed by a medical image processing apparatus according to a third embodiment;

FIG. 11A is a diagram illustrating a display example of a process performed by the medical image processing apparatus according to the third embodiment;

FIG. 11B is a diagram illustrating another display example of a process performed by the medical image processing apparatus according to the third embodiment; and

FIG. 12 is a flowchart illustrating the procedure of a process performed by a medical image processing apparatus according to a fourth embodiment.

### DETAILED DESCRIPTION

A medical image processing apparatus according to the present embodiment includes processing circuitry. The processing circuitry receives an instruction to move a slice position when a three-dimensional medical image including a plurality of slice images of a subject is displayed. The processing circuitry controls a display to display a slice image at a destination slice position as a first image when the received instruction is an instruction to move the slice position by less than a predetermined interval, and controls the display to display a second image reflecting information on a plurality of slice images including the slice image at the destination slice position when the received instruction is an instruction to move the slice position by more than the predetermined interval.

Embodiments of a medical image processing apparatus, a medical image processing method, and a computer program are described below in detail with reference to the drawings. The following is an example of a medical image processing system including the medical image processing apparatus.

### First Embodiment

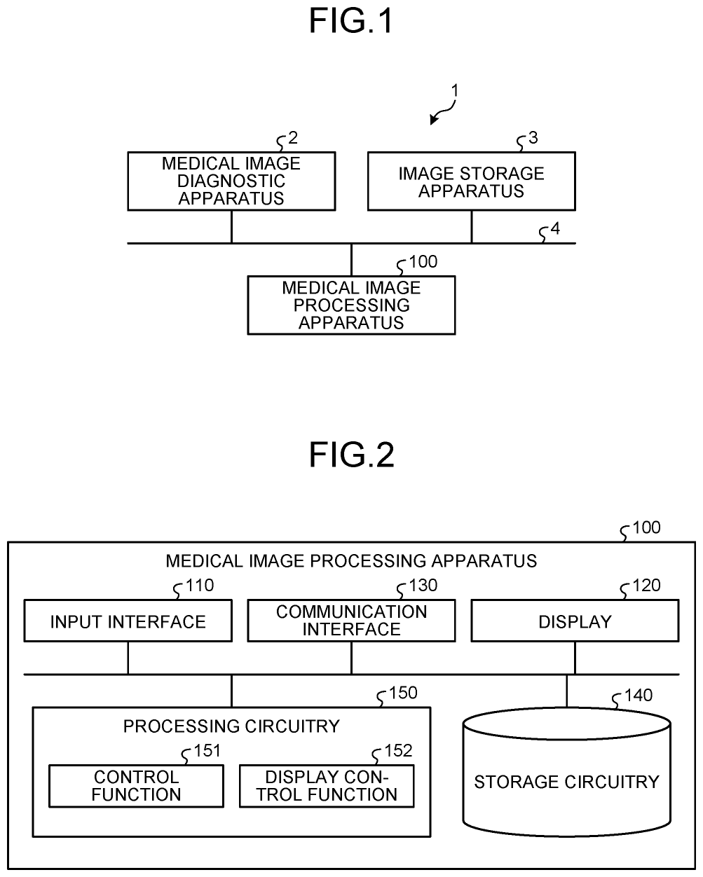

FIG. 1 is a diagram illustrating an example of a configuration of a medical image processing system 1 including a medical image processing apparatus 100 according to a first embodiment. The medical image processing system 1 illustrated in FIG. 1 includes the medical image processing apparatus 100, a medical image diagnostic apparatus 2, and an image storage apparatus 3. The medical image processing apparatus 100 is connected to the medical image diagnostic apparatus 2 and the image storage apparatus 3 by a network 4 such as an in-hospital local area network (LANl) installed in a hospital, for example. The apparatuses are capable of communicating with one another directly or indirectly. For example, when a picture archiving and communication system (PACS) is introduced into the medical image processing system 1, the apparatuses transmit and receive a medical image and the like in accordance with a digital imaging and communications in medicine (DICOM) standard.

The medical image diagnostic apparatus 2 is an X-ray diagnostic apparatus, an X-ray computed tomography (CT) apparatus, a magnetic resonance imaging (MRI) apparatus, an ultrasonic diagnostic apparatus, or a single photon emission computed tomography (SPECT) apparatus. The medical image diagnostic apparatus 2 is a positron emission computed tomography (PET) apparatus, a SPECT-CT apparatus in which a SPECT apparatus and an X-ray CT apparatus are integrated, a PET-CT apparatus in which a PET apparatus and an X-ray CT apparatus are integrated, a group of these apparatuses, or the like. The medical image diagnostic apparatus 2 can generate a two-dimensional medical image, a three-dimensional medical image (volume data), a time-series two-dimensional medical image, and a time-series three-dimensional medical image.

The medical image diagnostic apparatus 2 collects medical images by capturing an image of a subject. For example, an X-ray CT apparatus serving as the medical image diagnostic apparatus 2 moves an X-ray tube and an X-ray detector in a swiveling motion around a subject to which a contrast agent has been administered, detects X-rays transmitted through the subject, and collects projection data. On the basis of the collected projection data, the X-ray CT apparatus generates a two-dimensional CT image, a three-dimensional CT image (volume data), a time-series two-dimensional CT image, and a time-series three-dimensional CT image. Alternatively, on the basis of the collected projection data, the X-ray CT apparatus generates a plurality of two-dimensional CT images along predetermined directions. For example, the X-ray CT apparatus generates a two-dimensional CT image of a plurality of axial cross sections following a body axial direction.

The medical image diagnostic apparatus 2 transmits the generated medical images to the image storage apparatus 3. When transmitting the medical images to the image storage apparatus 3, the medical image diagnostic apparatus 2 transmits ancillary information such as a patient ID identifying a patient, an examination ID identifying an examination, a device ID identifying the medical image diagnostic apparatus 2, a series ID identifying one-time of imaging by the medical image diagnostic apparatus 2, and the like.

The image storage apparatus 3 is a database that stores the medical images. Specifically, the image storage apparatus 3 includes storage circuitry, and stores the medical images transmitted from the medical image diagnostic apparatus 2 in the storage circuitry, thereby storing the medical images. The storage circuitry of the image storage apparatus 3 is, for example, a semiconductor memory element such as a random access memory (RAM) and a flash memory, or a storage device such as a hard disk and an optical disk. The medical images stored in the image storage apparatus 3 are stored in association with the patient ID, the examination ID, the device ID, the series ID, and the like. Therefore, the medical image processing apparatus 100 can acquire necessary medical images from the image storage apparatus 3 by performing a search using the patient ID, the examination ID, the device ID, the series ID, and the like.

The medical image processing apparatus 100 is an image processing apparatus that performs image processing on medical images, such as a workstation, a picture archiving and communication system (PACS) image server or viewer, various apparatuses in an electronic medical record system, and the like. The medical image processing apparatus 100 performs various processes on medical images acquired from the medical image diagnostic apparatus 2 or the image storage apparatus 3. In the present embodiment, the medical image processing apparatus 100 is an apparatus used, for example, by a physician (or “diagnostic imaging physician” or “radiologist”) to observe or interpret medical images.

FIG. 2 is a diagram illustrating an example of the configuration of the medical image processing apparatus 100 according to the first embodiment. As illustrated in FIG. 2, the medical image processing apparatus 100 includes an input interface 110, a display 120, a communication interface 130, storage circuitry 140, and processing circuitry 150.

The input interface 110 has a pointing device such as a mouse, keyboard, and the like, receives input of various operations for the medical image processing apparatus 100 from a physician who is a user, and transmits information on instructions and settings received from the user to the processing circuitry 150.

The display 120 is a monitor referred to by the user. Under the control of the processing circuitry 150, the display 120 displays images to the user or displays a graphical user interface (GUI) for receiving various instructions, various settings, and the like from the user via the input interface 110. The communication interface 130 is a network interface card (NIC) or the like, and communicates with other devices. The display 120 is an example of a display.

The storage circuitry 140 is, for example, a semiconductor memory element such as a RAM or a flash memory, or a storage device such as a hard disk or an optical disk. The storage circuitry 140 stores three-dimensional medical images being the medical images acquired from the medical image diagnostic apparatus 2 or the image storage apparatus 3 and including a plurality of slice images of a subject.

The processing circuitry 150 controls the components of the medical image processing apparatus 100. For example, as illustrated in FIG. 2, the processing circuitry 150 performs a control function 151 and a display control function 152. For example, respective processing functions performed by the control function 151 and the display control function 152, which are the components of the processing circuitry 150, are stored in the storage circuitry 140 in the form of computer programs executable by a computer. The processing circuitry 150 is a processor that reads the computer programs from the storage circuitry 140 and executes the read computer programs, thereby implementing functions corresponding to the executed computer programs. In other words, the processing circuitry 150 in the state of having read the computer programs has the functions illustrated in the processing circuitry 150 in FIG. 2. The control function 151 is an example of a reception unit and a generation unit, and the display control function 152 is an example of a display control unit.

The term “processor” used in the above description means, for example, circuitry such as a central processing unit (CPU), a graphics processing unit (GPU), or an application specific integrated circuit (ASIC). The term “processor” means circuitry such as a programmable logic device. Examples of the programmable logic device include a simple programmable logic device (SPLD) and a complex programmable logic device (CPLD). Examples of the programmable logic device include a field programmable gate array (FPGA). When the processor is, for example, a CPU, the processor reads out and executes the computer programs stored in the storage circuitry 140 to implement the functions. On the other hand, when the processor is, for example, an ASIC, the computer programs are directly incorporated in the circuitry of the processor instead of storing the computer programs in the storage circuitry 140. Each processor of the present embodiment is not limited to being configured as a single piece of circuitry for each processor, and one processor may be configured by combining a plurality of pieces of independent circuitry to implement the functions thereof. The plurality of components in FIG. 2 may be integrated into one processor to implement the functions thereof.

So far, the overall configuration of the medical image processing system 1 including the medical image processing apparatus 100 according to the present embodiment has been described. With such a configuration, the processing circuitry 150 of the medical image processing apparatus 100 includes the control function 151 and the display control function 152 to be able to assist in observing three-dimensional medical images, and performs the following processing.

When displaying a three-dimensional medical image including a plurality of slice images of a subject, the control function 151 receives an instruction to move a display position (slice position) through the input interface 110. The slice image is, for example, a two-dimensional CT image of an axial section. When the received instruction is an instruction to move the display position (slice position) by less than a predetermined interval (for example, by one position), the display control function 152 controls the display 120 to display a slice image at a next destination position (destination slice position) as a first image. When the received instruction is an instruction to move the display position (slice position) by more than the predetermined interval (for example, an instruction to skip one or more slice positions), the display control function 152 controls the display 120 to display a second image reflecting information on a plurality of slice images including the slice image at the next destination position (destination slice position).

In this way, in the medical image processing apparatus 100 according to the present embodiment, even when a user wants to quickly observe an entire three-dimensional medical image, information on all slice images included in the three-dimensional medical image is displayed on the display 120 to be able to assist the user in observing the three-dimensional medical image. Specifically, the medical image processing apparatus 100 according to the present embodiment can assist in observing the three-dimensional medical image by controlling the display 120 to collectively display information on a plurality of slice images included in the three-dimensional medical image at once, so that there are no omissions in the display of the slice images.

The second image is, for example, a slab image based on a group of slice images including adjacent slice images having a number corresponding to the amount of movement determined by the received instruction and including a slice image at a destination position determined by the amount of movement. The group of slice images from which the slab image is derived includes slice images between the slice image at the destination position and a slice image at a pre-movement position.

In the following, the slice image and the slab image may be collectively referred to as a planar image. In the following, the position of a slab image generated at the position of a slice image in the three-dimensional medical image (hereinafter, referred to as a slice position) is described as a slab position. In the following, moving the slice position by +1 is referred to as +1 slice feeding, moving the slice position by −1 is referred to as −1 slice feeding, and +1 slice feeding and −1 slice feeding are collectively referred to as ±1 slice feeding. In the following, moving the slice position by +n is referred to as +n slice feeding, moving the slice position by −n is referred to as −n slice feeding, and +n slice feeding and −n slice feeding are collectively referred to as ±n slice feeding. Here, n is a predetermined integer of 2 or more.

The control function 151 has a generation function of generating a slab image from a plurality of slice images. With such a generation function, the control function 151 can pre-generate a plurality of slab images each having a slab thickness. Specifically, for each slice image constituting the three-dimensional medical image, the control function 151 generates slab images including the slice image and having a plurality of different slab thicknesses, and stores a group of the generated slab images in the storage circuitry 140. More specifically, the control function 151 reads a plurality of slice images included in the three-dimensional medical image from the storage circuitry 140, and generates a plurality of slab images for each of the plurality of slab thicknesses. In this case, each slab image at one slab thickness is generated at each slice position of the plurality of slice images. Therefore, the number of slice images can be equal to the number of slab images at one slab thickness. The plurality of slab thicknesses refer to all slab thicknesses to be used in processes to be described below, and are all slab thicknesses that are twice or more the slice spacing of the slice image and up to a multiple determined in advance. In this case, the display control function 152 acquires a slab image to be subsequently displayed, corresponding to the second image, from the group of the slab images stored in the storage circuitry 140 and controls the display 120 to display the acquired slab image. Thus, when the display control function 152 requests a generated slab image, the control function 151 may simply read the generated slab image stored in the storage circuitry 140.

Alternatively, when the display control function 152 requests a slab image having a specific slab thickness and located at a specific slab position, the control function 151 may generate the requested slab image in real time (on demand). Specifically, the display control function 152 controls the control function 151 to generate a slab image to be subsequently displayed, corresponding to the second image, and controls the display 120 to display the slab image generated by the control function 151.

The slab image is generated from a plurality of mutually adjacent slice images. Specifically, the slab image is an image reflecting information on a plurality of slice images, including a slice image at a destination position. Each pixel value of the slab image is acquired by computing respective pixel values at corresponding pixel positions of the plurality of slice images. Examples of the method of computing each pixel value include calculating an average value, calculating a median value, acquiring a maximum value, and acquiring a minimum value. The method of acquiring each pixel value of the slab image by acquiring the maximum value of the respective pixel values of the plurality of slice images is called a maximum intensity projection (MIP) method. Similarly, the method of acquiring each pixel value of the slab image by acquiring the minimum value is called a minimum intensity projection (MinIP) method. In this way, the slab image is generated from a group of the slice images by the maximum intensity projection method, the minimum intensity projection method, or a statistical process such as calculating an average value or calculating a median value. The slab image may also be generated using other computation methods.

The slab position described above is predefined as one of a center slice position, a first slice position, or a last first slice position of the plurality of slice images used to generate the slab image. The first slice position means, for example, the position of a slice image that shows the most head side of the subject, and the last slice position means, for example, the position of a slice image that shows the most foot side of the subject. For example, the + direction of the slice feeding is, for example, the direction from a slice image showing the head side of the subject to a slice image showing the foot side of the subject, and the − direction of the slice feeding is, for example, the direction from the slice image showing the foot side of the subject to the slice image showing the head side of the subject.

For example, when the direction of the slice feeding is the + direction, the display control function 152 may use the slab position as the last slice position. When the direction of the slice feeding is the − direction, the display control function 152 may use the slab position as the first slice position. Thus, when the ±n slice feeding to be described below is performed, all slice images between a display position before update and a display position after the update can be included in a slab image to be displayed on the display 120. Alternatively, the slab position can be used as the center slice position regardless of the direction of the slice feeding. In this case, the slab image is once displayed at the display position before the update just before the display control function 152 starts slice feeding to be described below. Thus, all slice images between a display position before update and a display position after the update can be included in a slab image to be displayed on the display 120.

The display control function 152 acquires a planar image (slice image or slab image) located at a predetermined display position and displays the acquired planar image on the display 120. For example, immediately after the control function 151 reads the three-dimensional medical image and stores the three-dimensional medical image in the storage circuitry 140, the display control function 152 reads a slice image located at a first slice position of the three-dimensional medical image from the storage circuitry 140 and controls the display 120 to display the read slice image. For example, when the display position is updated by a user instruction for ±n slice feeding as described below, that is, when the control function 151 receives an instruction to move the display position by skipping one or more display positions, the display control function 152 acquires a slab image located at the updated display position from the storage circuitry 140 and controls the display 120 to display the acquired slab image. Alternatively, the control function 151 generates the slab image located at the updated display position in real time, and the display control function 152 controls the display 120 to display the generated slab image.

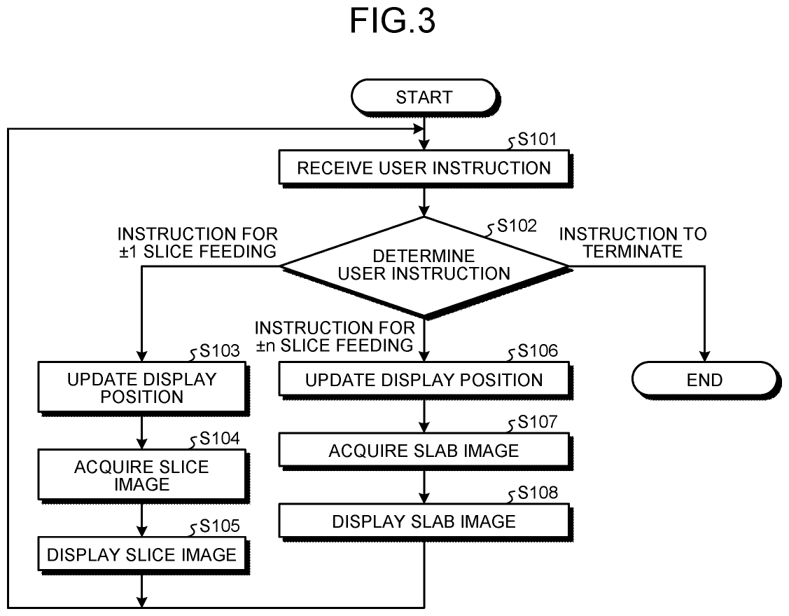

Each function of the medical image processing apparatus 100 is described below in detail with reference to FIG. 3. FIG. 3 is a flowchart illustrating the procedure of a process (medical image processing method) performed by the medical image processing apparatus 100 according to the first embodiment.

Steps S101 to S108 in FIG. 3 are steps performed by the processing circuitry 150 that reads computer programs corresponding to the control function 151 and the display control function 152 from the storage circuitry 140 and executes the read computer programs.

At step S101, the control function 151 receives input of user instructions via the input interface 110. The user can enter the instructions in a variety of ways.

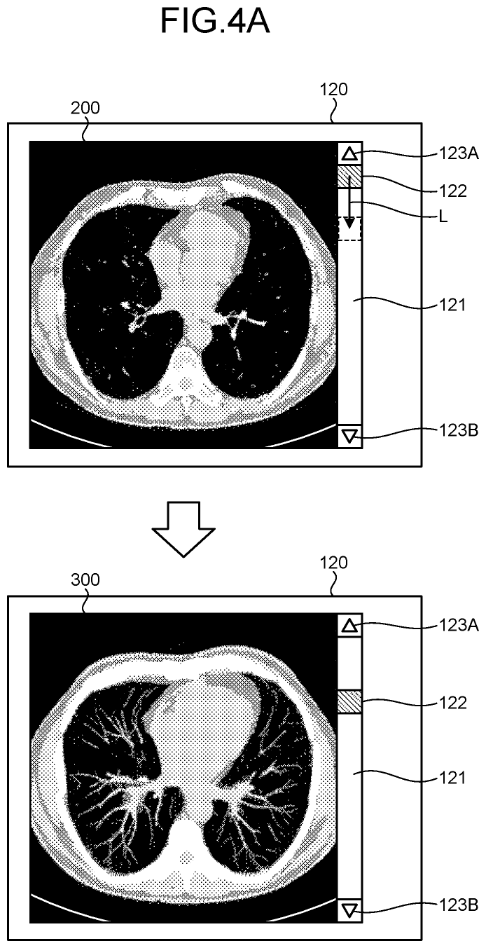

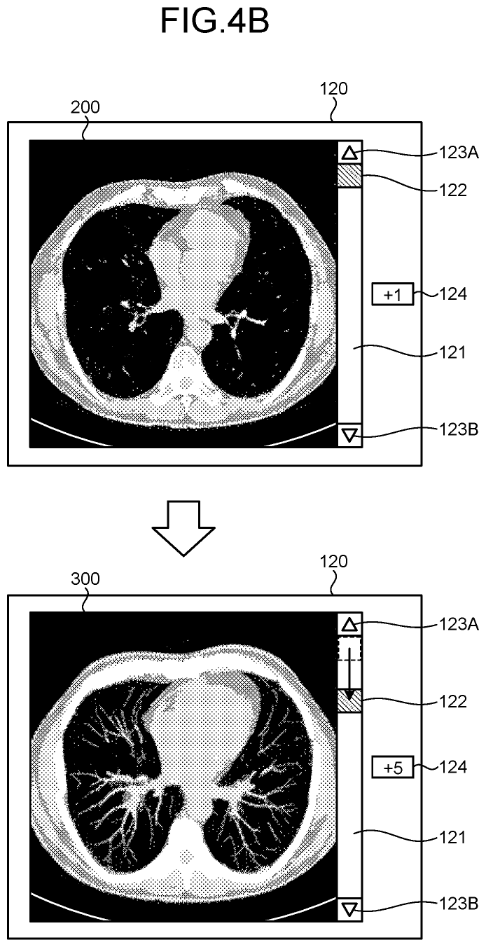

For example, by performing an operation of moving a mouse, which is the input interface 110, while clicking a button of the mouse (what is called click and drag operation), the user can instruct the amount of movement of slice feeding according to the speed of mouse movement. An interface for instructing the amount of movement of slice feeding is described with reference to FIGS. 4A and 4B. FIGS. 4A and 4B are diagrams illustrating a specific example of a user operation at step S101 in FIG. 3 as a process performed by the medical image processing apparatus according to the first embodiment. FIG. 4A is an example of a case in which the amount of movement is instructed by a click and drag operation.

For example, as illustrated in FIG. 4A, the display control function 152 controls the display 120 to display a scroll bar 121 along with a slice image 200. The scroll bar 121 has a knob 122 and arrows 123A and 123B. The knob 122 is a bar arranged on the scroll bar 121 and serves as what is called a “knob”. The knob 122 indicates a currently displayed position. A display slice can be changed by dragging the knob 122. The knob 122 may also be referred to as a thumb, a scroller, a scroll thumb, or the like. The arrows 123A and 123B are arranged at both ends of the scroll bar 121. Specifically, the arrow 123A is arranged at the top of the scroll bar 121, and when the user clicks on the arrow 123A by using the mouse, the control function 151 receives an instruction to move the display position of an image back by one image. The arrow 123B is arranged at the bottom of the scroll bar 121, and when the user clicks on the arrow 123B by using the mouse, the control function 151 receives an instruction to move the display position of an image by one image. When the user continues to press the arrows 123A and 123B by using the mouse, the control function 151 receives continuous movement.

For example, when the user performs a mouse operation (click and drag operation), the display control function 152 determines the amount of movement of slice feeding according to the speed of mouse movement. Specifically, as illustrated in FIG. 4A, the display control function 152 determines the amount of movement of slice feeding on the basis of the speed of mouse movement according to an operation amount L of the drag operation when the user uses the knob 122 with the mouse. For example, the display control function 152 adaptively determines the amount of movement (natural number m) by using a table that associates the amount of change per unit time in the operation amount L with the amount of movement, or a relational formula. When the amount of movement is determined, the control function 151 receives an instruction to move a display position by the determined amount of movement. When m is 1, the user instruction is an instruction for ±1 slice feeding, and when m is 2 or more, the user instruction is an instruction for ±n slice feeding.

For example, the user can instruct ±1 slice feeding or ±n slice feeding by pressing a predetermined key such as arrow keys on the keyboard that is the input interface 110. To give a specific example, the user can give an instruction to move a display position by +1 (to send an image display position by +1) by pressing a downward arrow key “↓” on the keyboard, and give an instruction to move the display position by −1 (to send the image display position by −1) by pressing an upward arrow key “↑” on the keyboard. The user can also give an instruction to move the display position by +n (n is an integer of 2 or more) (to send the image display position by +n) by pressing a rightward arrow key “,” on the keyboard, and give an instruction to move the display position by −n (to send the image display position by −n) by pressing a leftward arrow key “←” on the keyboard.

For example, the user can instruct ±n slice feeding by pressing a predetermined auxiliary key such as a shift key “Shift”, a control key “Ctrl”, or an Alt key “Alt” on the keyboard, and a key other than the predetermined auxiliary key at the same time. To give a specific example, when the user presses the arrow key “↓” or “↑” on the keyboard, the display position can be moved by +1 or −1, and when the shift key “Shift” and the arrow key “↓” or “↑” are pressed simultaneously, the display position can be moved by +n or −n.

The values of n described above need to be predetermined, but for example, different values of n may be assigned to each auxiliary key such as n is 5 when the user presses the shift key “Shift”, n is 8 when the user presses the control key “Ctrl”, and n is 10 when the user presses the alt key “Alt”. As an example of assigning different values of n to the keys, fixed values “2”, “3”, “4”, “5” . . . may also be assigned to function keys “F2”, “F3”, “F4”, “F5” . . . on the keyboard.

The user may also be able to set the value of n to be assigned to each key or auxiliary key by using a text box or the like. For example, as illustrated in FIG. 4B, the display control function 152 controls the display 120 to display a text box 124 along with the slice image 200 and the scroll bar 121. For example, the display control function 152 determines the amount of movement of slice feeding by a fixed value input to the text box 124 by the user. Specifically, assume that when the display control function 152 is displaying, for example, “1” on the text box 124 as a fixed value, the user inputs “5” to the text box 124 as a fixed value by using the input interface 110. In this case, the display control function 152 determines the amount of movement of slice feeding by the fixed value “5” input by the user. Specifically, the display control function 152 determines the amount “+5” of movement of slice feeding, for example, by a click operation when the user inputs “5” to the text box 124 as a fixed value by using the input interface 110 and uses the arrow 123B with the mouse.

Returning now back to FIG. 3, at step S102, the control function 151 determines a next process to be performed according to the user instruction. When the user instruction is an instruction for ±1 slice feeding, the procedure in FIG. 3 proceeds to step S103, when the user instruction is an instruction for ±n slice feeding, the procedure in FIG. 3 proceeds to step S106, and when the user instruction is an instruction to terminate the procedure, the procedure in FIG. 3 ends.

Although there are many other types of user instructions related to the control performed by the control function 151, user instructions not directly related to the embodiment are not described.

At step S103, the display control function 152 moves the display position of a planar image displayed on the display 120 by +1 or −1, depending on whether the amount of slice movement in the instruction for ±1 slice feeding is +1 or −1.

At step S104, the display control function 152 reads a slice image located at an updated display position from the storage circuitry 140.

At step S105, the display control function 152 controls the display 120 to display the read slice image (slice display). Subsequently, the procedure in FIG. 3 returns to step S101.

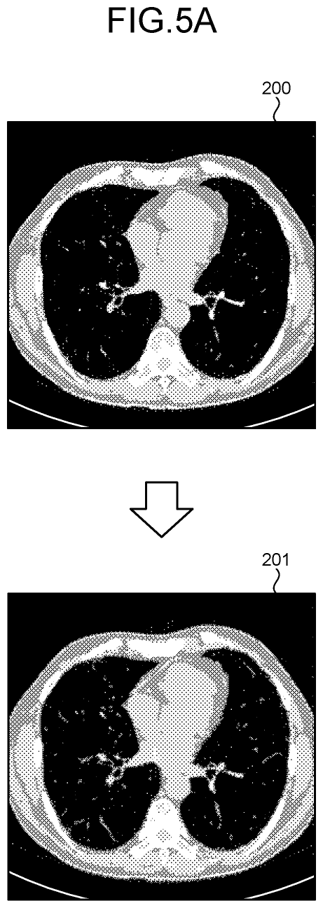

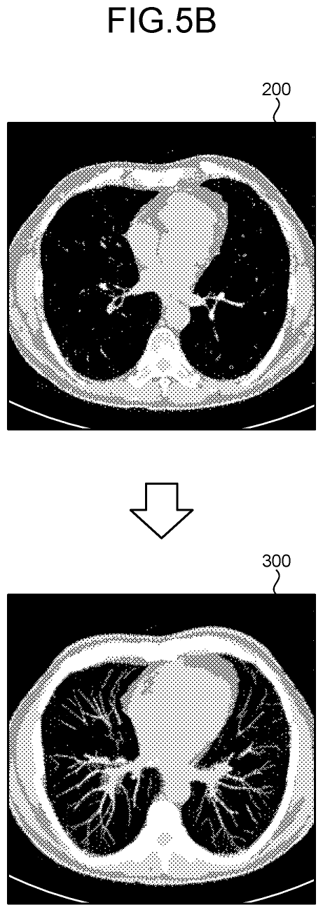

FIG. 5A illustrates a display example when steps S103 to S105 in FIG. 3 are performed as a process performed by the medical image processing apparatus 100 according to the present embodiment.

As illustrated in FIG. 5A, the display control function 152 first controls the display 120 to display the slice image 200. Subsequently, when the control function 151 receives an instruction to move the display position of the slice image by one image (for example, an instruction to move the slice image by +1), the display control function 152 controls the display 120 to display a slice image 201 located at a position where the display position of the slice image 200 has been moved by one image.

Returning now back to FIG. 3, at step S106, the display control function 152 moves the display position of the planar image displayed on the display 120 by +n or −n, depending on whether the amount of slice movement in the instruction for ±n slice feeding is +n or −n.

At step S107, the display control function 152 acquires, from the storage circuitry 140, a slab image (having a slab thickness) located at the updated display position and generated from n slices. At step S108, the display control function 152 controls the display 120 to display the acquired slab image (slab display). Subsequently, the procedure in FIG. 3 returns to step S101.

At step S107, the control function 151 may generate the slab image located at the updated display position in real time, and at step S108, the display control function 152 may control the display 120 to display the generated slab image.

FIG. 5B illustrates a display example when steps S106 to S108 in FIG. 3 are performed as a process performed by the medical image processing apparatus 100 according to the present embodiment.

As illustrated in FIG. 5B, the display control function 152 first controls the display 120 to display the slice image 200. Subsequently, when an instruction to move the display position of the slice image 200 by skipping one or more display positions (for example, an instruction to move the display position by +n) is received as an instruction to skip (thin out) the display position of the slice image 200, the control function 151 generates a slab image 300 based on a group of slice images including adjacent slice images having a number corresponding to the amount of movement determined by the received instruction and including a slice image at a destination position determined by the amount of movement. The display control function 152 controls the display 120 to display the slab image 300 generated by the control function 151.

When displaying the slab image 300, the display control function 152 controls the display 120 to display the slab image 300 so that a slice image at a destination position determined by the amount of movement corresponding to n slice images serves as a slab center.

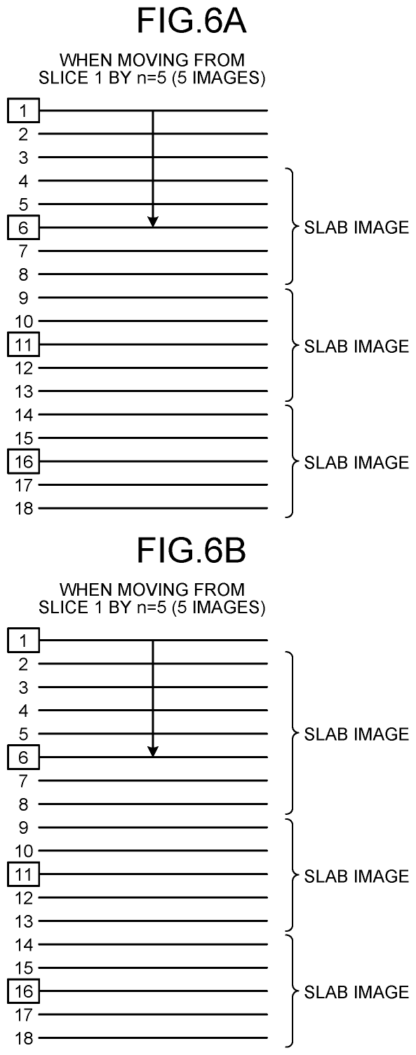

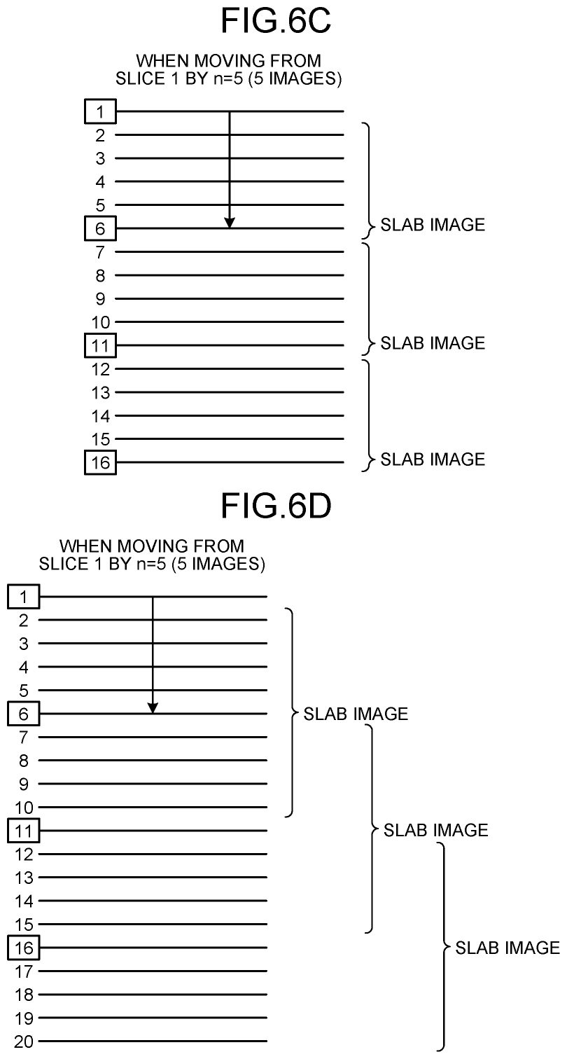

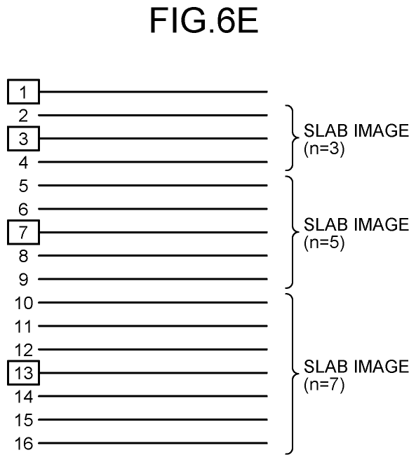

An example illustrated in FIG. 6A assumes that the control function 151 first receives an instruction to move the display position of the slice image 200 by the amount of movement corresponding to 5 slice images (n is 5) from a first slice image “slice 1” as an instruction to thin out the display position of the slice image 200. In this case, the display control function 152 acquires, from the storage circuitry 140, a slab image in which a sixth slice image “slice 6” at a destination position determined by the amount of movement corresponding to 5 slice images serves as a slab center, the slab image being based on a group “slice 4” to “slice 8” of five adjacent slice images corresponding to the amount of movement. The display control function 152 controls the display 120 to display the acquired slab image. Subsequently, by a next instruction, a slab image, in which an eleventh slice image “slice 11” serves as a slab center, is displayed on the display 120, the slab image being based on a group “slice 9” to “slice 13” of slice images. Similarly, by a next instruction, a slab image, in which a sixteenth slice image “slice 16” serves as a slab center, is displayed on the display 120, the slab image being based on a group “slice 14” to “slice 18” of slice images.

However, in the example illustrated in FIG. 6A, second and third slice images “slice 2” and “slice 3” may not be displayed on the display and may not observed by the user. Therefore, in an example illustrated in FIG. 6B, the display control function 152 acquires, from the storage circuitry 140, a slab image in which a sixth slice image “slice 6” serves as a slab center, the slab image being based on a group “slice 2” to “slice 8” of adjacent slice images. The display control function 152 controls the display 120 to display the acquired slab image. Thus, the slice images “slice 2” and “slice 3” are also displayed on the display 120 as slab images and observed by the user so that undisplayed slice images are not present. Subsequently, by a next instruction, a slab image based on a group “slice 9” to “slice 13” of slice images is displayed on the display 120, as in the example illustrated in FIG. 6A. Similarly, by a next instruction, a slab image based on a group “slice 14” to “slice 18” of slice images is displayed on the display 120.

After displaying a first slice image “slice 1” on the display 120 in FIG. 6A, the display control function 152 may display the following images instead of controlling the display 120 to display a slab image based on the group “slice 4” to “slice 8” of slice images. For example, the display control function 152 controls the display 120 to display the first slice image “slice 1”, a slab image based on a group “slice 1” to “slice 3” of slice images, and the group “slice 4” to “slice 8” of slice images. In this way, by once displaying the slab image at a pre-update display position just before the display control function 152 starts slice feeding, all slices between the pre-update position and a post-update display position can be included in the slab image displayed on the display 120. When receiving an instruction to move the display position by the amount of movement corresponding to 5 slice images (n is 5) after the sixth slice image “slice 6” is displayed, the display control function 152 may control the display 120 to display a slab image based on the group “slice 2” to “slice 8” of slice images in which the “slice 6” is a center slice position, and then control the display 120 to display a slab image based on the group “slice 9” to “slice 13” of slice images.

An example illustrated in FIG. 6C is an example of generating a slab image including slice images to be skipped without excess or deficiency, and the display control function 152 acquires, from the storage circuitry 140, a slab image based on a group “slice 2” to “slice 6” of adjacent slice images. The display control function 152 controls the display 120 to display the acquired slab image. In a next instruction, a slab image based on a group “slice 7” to “slice 11” of slice images is displayed on the display 120. Similarly, by a next instruction, a slab image based on a group “slice 12” to “slice 16” of slice images is displayed on the display 120.

In an example illustrated in FIG. 6D, the number of groups of slice images is set to “n+n−1=2n−1” so that information on second and third slice images “slice 2” and “slice 3” is displayed and a slab image in which a slice image “slice 6” at a destination position serves as a center is displayed. In this case, since “n is 5”, the number of groups of slice images is 9. As a result, in the example illustrated in FIG. 6D, a part of a group of slice images for generating a slab image overlaps a part of a group of slice images for generating a slab image to be displayed next to the slab image. In the example illustrated in FIG. 6D, the display control function 152 acquires, from the storage circuitry 140, a slab image in which the sixth slice image “slice 6” serves as a slab center, the slab image being based on a group “slice 2” to “slice 10” of adjacent second to tenth slice images. The display control function 152 controls the display 120 to display the acquired slab image. In a next instruction, a slab image in which an eleventh slice image “slice 11” serves as a slab center, is displayed on the display 120, the slab image being based on a group “slice 7” to “slice 15” of slice images. Similarly, by a next instruction, a slab image in which a sixteenth slice image “slice 16” serves as a slab center, is displayed on the display 120, the slab image being based on a group “slice 12” to “slice 20” of slice images.

The amount of movement may be different for each instruction. In an example illustrated in FIG. 6E, when an instruction for slice feeding is given with different n each time such as n is 3, n is 5, and n is 7, the display control function 152 acquires, from the storage circuitry 140, slab images based on 3, 5, and 7 slice images, respectively. First, the display control function 152 acquires a slab image in which a third slice image “slice 3” serves as a slab center, the slab image being based on a group “slice 2” to “slice 4” of adjacent slice images, and controls the display 120 to display the acquired slab image. Subsequently, the display control function 152 acquires a slab image in which a seventh slice image “slice 7” serves as a slab center, the slab image being based on a group “slice 5” to “slice 9” of adjacent slice images, and controls the display 120 to display the acquired slab image. Subsequently, the display control function 152 acquires a slab image in which a thirteenth slice image “slice 13” serves as a slab center, the slab image being based on a group “slice 10” to “slice 16” of adjacent slice images, and controls the display 120 to display the acquired slab image.

In the examples illustrated in FIGS. 6A to 6E, the control function 151 may generate slab images in real time, and the display control function 152 may control the display 120 to display the generated slab images.

In this way, in the medical image processing apparatus 100 according to the present embodiment, when a user gives an instruction to thin out a slice images in order to quickly observe a three-dimensional medical image, the thinned-out slice image is displayed as the slab image 300 and is observed by the user. Therefore, in accordance with the medical image processing apparatus 100 according to the present embodiment, even when a user wants to quickly observe an entire three-dimensional medical image, information on all slice images included in the three-dimensional medical image is displayed on the display 120 to be able to assist the user in observing the three-dimensional medical image.

The storage circuitry 140 may store a second three-dimensional medical image to be compared with a first three-dimensional medical image that is a three-dimensional medical image. The first three-dimensional medical image and the second three-dimensional medical image are medical images acquired from the medical image diagnostic apparatus 2 or the image storage apparatus 3. Specifically, the first three-dimensional medical image is a current image and the second three-dimensional medical image is a past image to be compared with the current image. Alternatively, the second three-dimensional medical image is a three-dimensional processed image generated by using the first three-dimensional medical image. For example, the second three-dimensional medical image is a three-dimensional processed image obtained by removing an area corresponding to a bone from the first three-dimensional medical image. Alternatively, the second three-dimensional medical image is a difference image between a current image and a past image to be compared with the current image. For example, when displaying the first three-dimensional medical image, the display control function 152 displays the second three-dimensional medical image in conjunction with the first three-dimensional medical image.

Specifically, when the display control function 152 displays different planar images (for example, slab images) in two or more different display areas of the display 120 and two or more planar images are images associated with to each other, the procedure in FIG. 3 can be simultaneously applied to the two or more planar images. That is, on the basis of one user instruction, the display of the two or more planar images can be updated in conjunction with the user instruction. For example, assume that the control function 151 simultaneously reads a three-dimensional medical image and a three-dimensional processed image generated by using the three-dimensional medical image. It is also assumed that the display control function 152 displays a first planar image obtained from the three-dimensional medical image and a second planar image obtained from the three-dimensional processed image, which are located at the same display position, side by side on the display 120. At this time, when a user instruction for ±n slice feeding is input from the input interface 110, the display control function 152 can simultaneously perform the process described with reference to FIG. 3 on both the first planar image and the second planar image. This allows the display control function 152 to update and display a first slab image obtained from the three-dimensional medical image in conjunction with a second slab image obtained from the three-dimensional processed image and located at the same display position as the first slab image.

As described above, in the medical image processing apparatus 100 according to the first embodiment, when a user gives an instruction for ±n slice feeding, a slab image generated from at least n slice images is displayed on the display 120. Thus, even when the user quickly performs slice feeding, a slab image including information on slice images having a number corresponding to the amount of slice movement is displayed on the display 120. Therefore, in accordance with the medical image processing apparatus 100 according to the present embodiment, even when a user wants to quickly observe an entire three-dimensional medical image, information on all slice images included in the three-dimensional medical image is displayed on the display 120 to be able to assist the user in observing the three-dimensional medical image.

The present embodiment describes an example in which a user sequentially gives instructions for slice feeding, but is not limited thereto. For example, the process in FIG. 3 can be applied even in the case of automatic slice feeding in which a planar image (for example, a slab image) is displayed on the display 120 while automatically and continuously switching a display position.

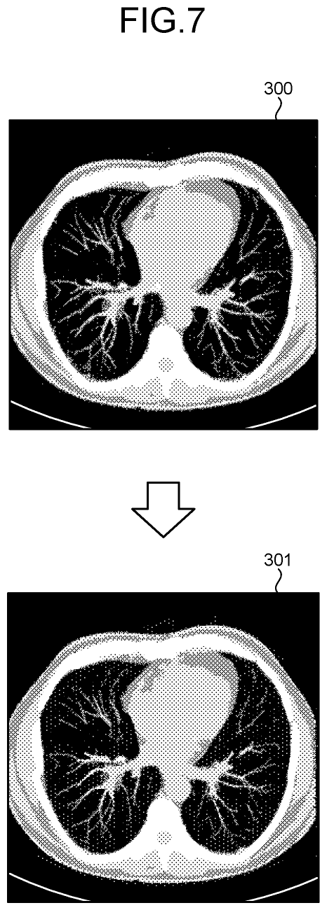

Specifically, a process of displaying a slab image including a slice image skipped by ±n slice feeding can be performed in the same way as the procedure in FIG. 3. In this case, for example, a user may be able to set the amount of one-time slice feeding in automatic slice feeding, and slice feeding may be performed according to the set value. For example, as illustrated in FIG. 7, the display control function 152 first controls the display 120 to display the slab image 300. When an instruction to move the display position of the slab image 300 is received, the display control function 152 determines a slice image at a next destination position by the same amount of slice feeding as the amount of slice feeding set when the slab image 300 has been displayed. Subsequently, the display control function 152 acquires a slab image 301 based on a group of slice images including the slice image at the next destination position and a group of adjacent slice images having a number corresponding to the amount of movement, and controls the display 120 to display the slab image 301. In this way, when the control function 151 receives an instruction to continuously move the display position by skipping one or more display positions, the display control function 152 controls slab images according to a next destination position to be sequentially displayed.

A user may also be able to instruct the display position update frequency N per unit time in the automatic slice feeding. In this case, the control function 151 may automatically perform ±1 slice feeding (slice display by ±1 slice feeding) when the display position update frequency N is approximately 1 times or less than a predetermined value (standard value of display position update frequency per unit time), and automatically perform ±n slice feeding (slab display by ±n slice feeding) when N is approximately n times the predetermined value. Alternatively, the control function 151 may automatically perform ±1 slice feeding (slice display by ±1 slice feeding) or ±n slice feeding (slab display by ±n slice feeding) depending on whether the display position update frequency N is approximately 1 times or less than or approximately n times the updatable frequency per unit time of the image display of the medical image processing apparatus 100. The value of the display position update frequency N may be calculated by obtaining an instruction of the total amount D (slices) of slice transitions and transition time s (seconds) from a user, and using N=D÷s.

### Second Embodiment

Since the configuration diagram of a medical image processing apparatus according to a second embodiment is the same as the configuration diagram in FIG. 1, a description thereof is omitted.

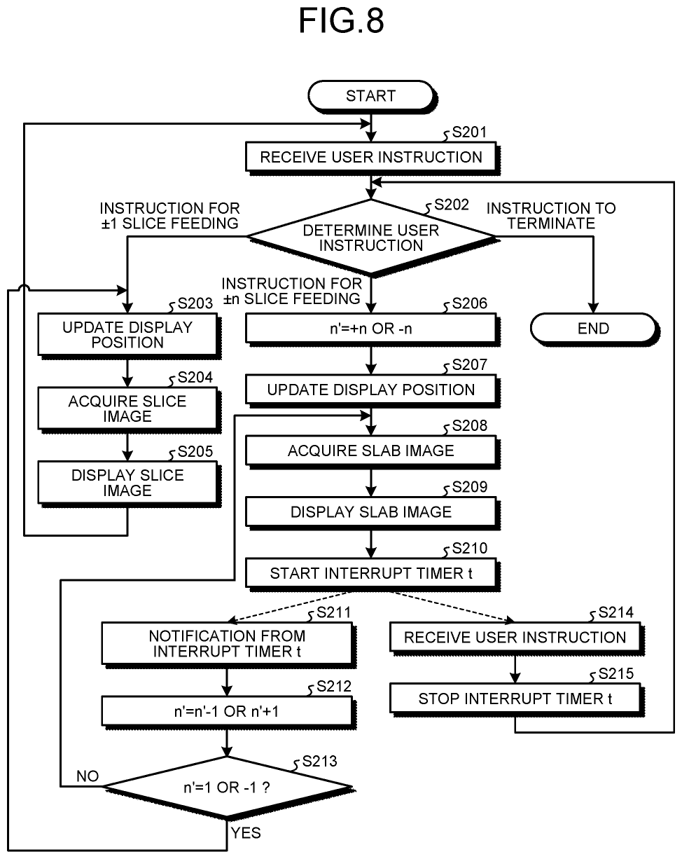

The second embodiment is different from the first embodiment in a procedure in which the processing circuitry 150 acquires a planar image (slice image or slab image) and displays the planar image on the display 120. A detailed processing procedure of the processing circuitry 150 is described below with reference to a flowchart in FIG. 8.

FIG. 8 is a flowchart illustrating the procedure of a process performed by a medical image processing apparatus according to a second embodiment; Since processes from step S201 to S205 in FIG. 8 are the same as the processes from step S101 to S105 in FIG. 3, a description thereof is omitted. When the control function 151 determines a next process to be performed according to the user instruction at step S202, the procedure in FIG. 8 proceeds to step S203 when the user instruction is an instruction for ±1 slice feeding, proceeds to step S206 when the user instruction is an instruction for ±n slice feeding, and ends when the user instruction is an instruction to terminate the procedure.

At step S206, the display control function 152 puts the amount+n or −n of slice movement in the instruction for ±1 slice feeding into a variable n′.

At step S207, the display control function 152 updates a display position. Specifically, the display control function 152 updates the display position of a planar image displayed on the display 120 to a position moved by n′.

At step S208, the display control function 152 acquires, from the storage circuitry 140, a slab image (having a slab thickness) located at the updated display position and generated on the basis of slice images having a number equal to an absolute value of n′.

At step S209, the display control function 152 controls the display 120 to display the acquired slab image.

At step S210, the control function 151 starts an interrupt timer t. After starting the interrupt timer t, the control function 151 calls an interrupt process by the timer t after a certain time elapses. After the interrupt timer t is started, user instructions can be input at any time. Accordingly, after step S210 is performed, when no user instruction is input until the certain time elapses, the procedure in FIG. 8 proceeds to step S211, and when a user instruction is input before a predetermined time elapses, the procedure in FIG. 8 proceeds to step S214.

At step S211, the interrupt timer t notifies the display control function 152 that the certain time has elapsed.

At step S212, the display control function 152 decreases the value of n′ by 1 when the value of the variable n′ is positive, and increases the value of n′ by 1 when the value of the variable n′ is negative. That is, a process is performed to gradually reduce a slab thickness over time after the ±n slice feeding. In this way, after the slab image is displayed on the display 120, the display control function 152 controls the slab thickness of the slab image to be reduced over time with the slab image including a slice image at a destination position during the period when no instruction to move the display position is received.

The time setting for interruptions at the present step may always be constant or may be changed according to the display status. For example, only when n′ is ±n (that is, immediately after the ±n slice feeding is performed), a relatively long time can be set so that the user can interpret the slab image, and when the absolute value of n′ is smaller than n in the process of step S212 to be described below (that is, when the slab image is being displayed while the slab thickness is gradually reduced), a relatively short time can be set.

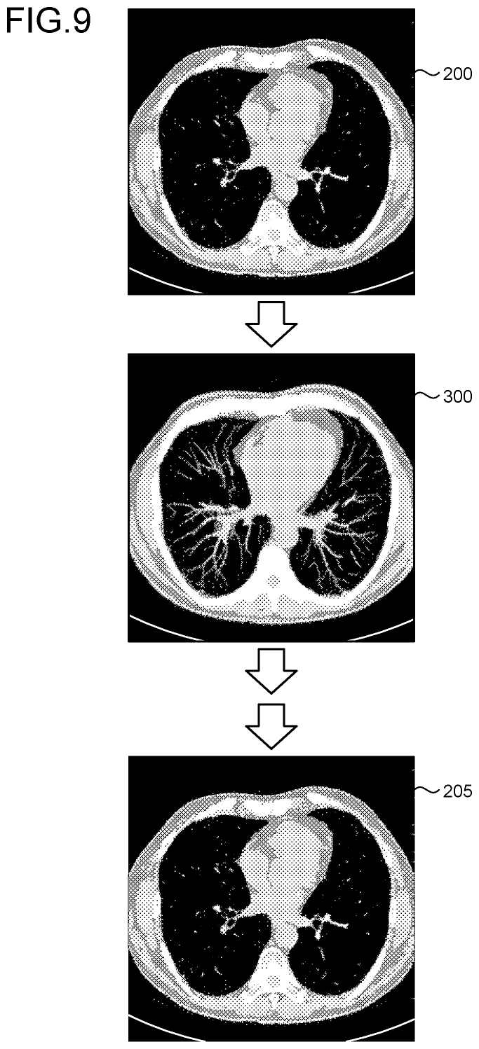

At step S213, the display control function 152 determines whether the value of the variable n′ is +1 or −1. When the value of the variable n′ is +1 or −1 (Yes at step S213), the procedure in FIG. 8 proceeds to step S203. That is, the slab display is shifted to slice display. For example, as illustrated in FIG. 9, when no instruction to move the display position is received for a predetermined time while the slab image 300 is displayed on the display 120, the display control function 152 controls the display 120 to display a slice image 205 located at the destination position within the group of the slice images from which the slab image 300 is derived.

On the other hand, when the value of the variable n′ is not +1 or −1 (No at step S213), the procedure in FIG. 8 proceeds to step S208. That is, slab display with a new slab thickness is performed. That is, in the process of switching from the slab image 300 to the slice image 205 in FIG. 9, a slab image having a slab thickness smaller than the slab thickness of the slab image 300 is displayed by the processes of steps S208 and S209.

At step S214, the control function 151 receives input of user instructions via the input interface 110.

At step S215, the control function 151 stops the interrupt timer t. After the interrupt timer t is stopped, the process of step S211 is not performed. Subsequently, the procedure in FIG. 8 returns to step S202.

When the display control function 152 displays different planar images in two or more different display areas of the display 120 and two or more planar images are images associated with each other, the control described in the first embodiment can be simultaneously applied to the two or more planar images. Accordingly, the display control function 152 can update the two or more planar images in conjunction with each other.

At step S208, the control function 151 may generate the slab image located at the updated display position in real time, and at step S209, the display control function 152 may control the display 120 to display the generated slab image.

As described above, in the medical image processing apparatus 100 according to the second embodiment, when a user gives an instruction for ±n slice feeding, a slab image generated from n slice images is displayed on the display. Subsequently, when no user instructions are input, a slab image having a smaller slab thickness is displayed on the display each time a predetermined time elapses, and finally a slice image is displayed on the display. As a result, when a physician as a user completes the instruction for ±n slice feeding and a predetermined time elapses, the display shifts from the slab display to the slice display. Thus, in accordance with the medical image processing apparatus 100 according to the second embodiment, when a user slowly performs slice feeding or performs no slice feeding, a slice image is displayed, thereby controlling the user to make detailed observations and assist in observing a three-dimensional medical image.

In the process of gradually reducing the slab thickness at step S212, the amount by which the slab thickness is reduced does not have to be one slice at a time, but may be a plurality of slices at a time. With such a configuration, the number of stages of switching from the slab display to the slice display can be controlled. For example, by setting the number of slices to be thinned to 2, the number of stages of switching from the slab display to the slice display can be reduced from 6 to 3.

The amount by which the slab thickness is reduced needs not be constant, but may change over time. Instead of gradually reducing the slab thickness, n′ may be set to 1 or −1 at step S212. With such a configuration, the slab display can be returned to the slice display immediately after the elapse of a predetermined time of ±n slice feeding.

### Third Embodiment

Since the configuration diagram of a medical image processing apparatus according to a third embodiment is the same as the configuration diagram in FIG. 1, a description thereof is omitted.

The third embodiment differs from the first and second embodiments in the following two points. The first is the difference in images read by the control function 151. The second is the difference in the procedure by which the processing circuitry 150 acquires a planar image and displays the planar image on the display 120. The two points different from the first and second embodiments are described below.

The third embodiment is an embodiment that can be performed when a first three-dimensional medical image that is a three-dimensional medical image and a second three-dimensional medical image to be described below are stored in the storage circuitry 140. The second three-dimensional medical image is a three-dimensional medical image of a subject taken including a captured part of the first three-dimensional medical image, and includes a slice image (thick slice image) having a slice thickness greater than a slice thickness of a slice image (thin slice images) constituting the first three-dimensional medical image.

The first three-dimensional medical image and the second three-dimensional medical image are medical images acquired from the medical image diagnostic apparatus 2 or the image storage apparatus 3. For example, the first three-dimensional medical image and the second three-dimensional medical image are three-dimensional X-ray CT images of the subject obtained in the same examination, and are images having different slice thicknesses from each other. In this case, when an instruction to move a display position by skipping one or more display positions is given, the display control function 152 controls the display 120 to display the slice image (thick slice images) constituting the second three-dimensional medical image as a second image.

For example, when a user instruction input from the input interface 110 is an instruction to read the above two three-dimensional medical images, the control function 151 reads the two three-dimensional medical images from the medical image diagnostic apparatus 2 or the image storage apparatus 3 and stores the read three-dimensional medical images in the storage circuitry 140. The control function 151 calculates the ratio a of a slice spacing of the first three-dimensional medical image and a slice spacing of the second three-dimensional medical image and stores the calculated ratio a in the storage circuitry 140. Thus, the process of the third embodiment to be described below can be performed.

When an instruction to read one three-dimensional medical image is received, the control function 151 may use the three-dimensional medical image as a first three-dimensional medical image and search whether another three-dimensional medical image corresponding to the second three-dimensional medical image is stored in the image storage apparatus 3. When the another three-dimensional medical image corresponding to the second three-dimensional medical image is stored, the control function 151 stores these two three-dimensional medical images in the storage circuitry 140. Thus, the process of the third embodiment to be described below can be performed.

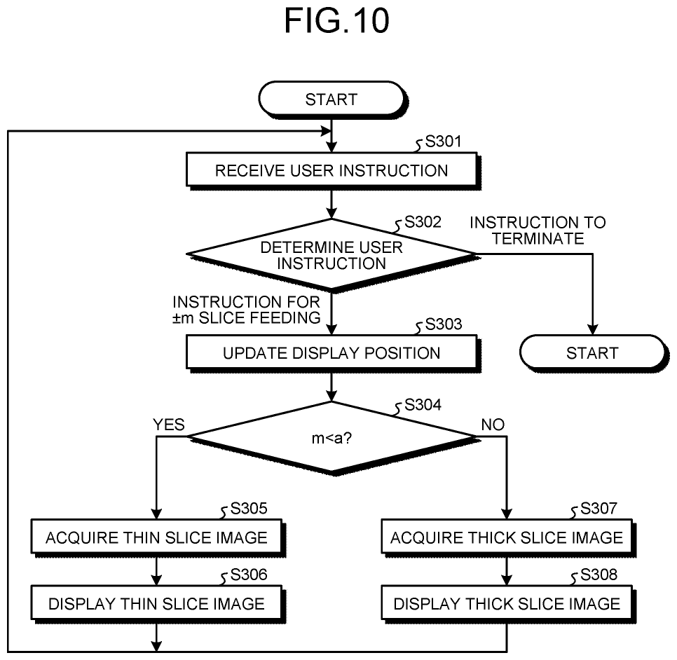

FIG. 10 is a flowchart illustrating the procedure of a process performed by a medical image processing apparatus according to a third embodiment;

At step S301, the control function 151 receives the input of user instructions via the input interface 110.

At step S302, the control function 151 determines a next process to be performed according to the user instruction. When the user instruction is an instruction for ±m slice feeding (m is a natural number), the procedure in FIG. 10 proceeds to step S303, and when the user instruction is an instruction to terminate the procedure, the procedure in FIG. 10 ends.

At step S303, the display control function 152 moves the display position of a slice image displayed on the display 120 by +m or −m, depending on whether the amount of slice movement in the instruction for ±m slice feeding is +m or −m. The display position is the slice position of a thin slice image.

At step S304, the display control function 152 reads the ratio a of the slice spacing from the storage circuitry 140, compares the ratio a with an absolute value m of the amount of slice movement in the instruction for ±m slice feeding, and determines whether m is less than a. When m is less than a, the procedure in FIG. 10 proceeds to step S305, and when m is equal to or greater than a, the procedure in FIG. 10 proceeds to step S307.

At step S305, the display control function 152 reads the thin slice image located at the display position updated at step S303 from the storage circuitry 140.

At step S306, the display control function 152 displays the read thin slice image on the display 120. Subsequently, the procedure in FIG. 10 returns to step S301.

At step S307, the display control function 152 reads, from the storage circuitry 140, a thick slice image located at a thick slice position corresponding to the updated display position (that is, thin slice position).

At step S308, the display control function 152 controls the display 120 to display the read thick slice image. Subsequently, the procedure in FIG. 10 returns to step S301.

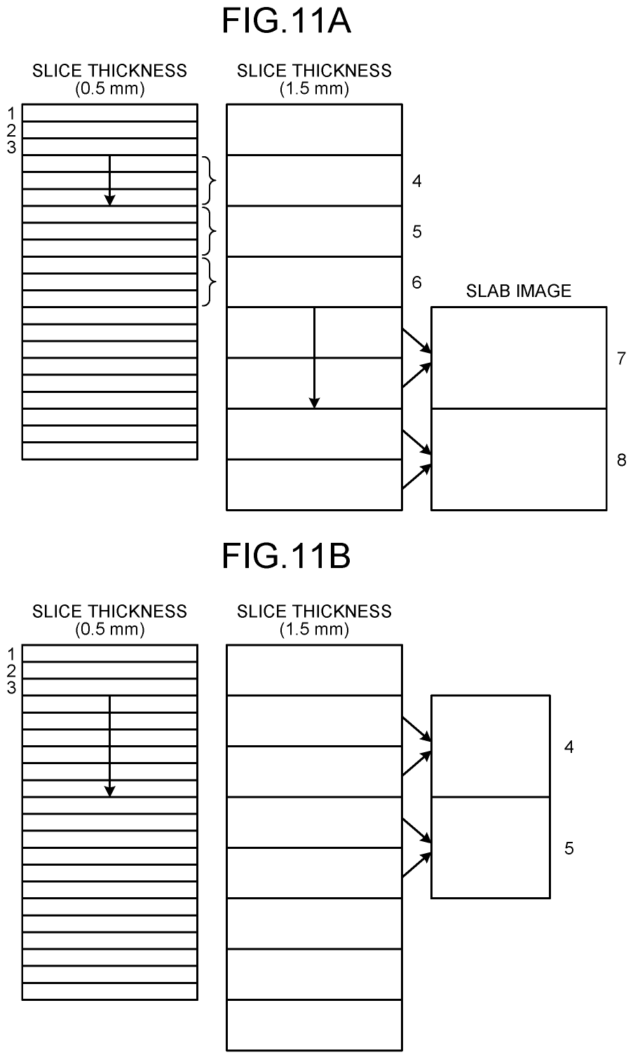

Display examples when the storage circuitry 140 stores the first three-dimensional medical image and the second three-dimensional medical image having different slice thicknesses are described with reference to FIGS. 11A and 11B. FIGS. 11A and 11B are diagrams illustrating display examples of the process performed by the medical image processing apparatus according to the third embodiment.

As described above, the second three-dimensional medical image is the three-dimensional medical image of the subject taken including the captured part of the first three-dimensional medical image. For example, the first three-dimensional medical image and the second three-dimensional medical image are three-dimensional CT images obtained by capturing the same part of the same subject. The first three-dimensional medical image includes a two-dimensional CT image of a plurality of axial cross-section each having a slice thickness of 0.5 mm, and the second three-dimensional medical image includes a two-dimensional CT image of a plurality of axial cross-section each having a slice thickness of 1.5 mm.

In FIG. 11A, the thin slice image is a slice image constituting the first three-dimensional medical image and has a slice thickness of, for example, 0.5 mm. The thick slice image is a slice image constituting the second three-dimensional medical image and has a slice thickness of, for example, 1.5 mm.

In the example illustrated in FIG. 11A, the display control function 152 first controls the display 120 to display a thin slice image having a slice thickness of 0.5 mm as first to third display images by moving a display position one by one. In a case in which an instruction to move the display position by skipping one or more display positions is given, the amount of movement is equal to greater than the slice thickness of the thick slice image, the control function 151 controls the following process to be performed. For example, assume that the amount of movement is the slice thickness of the thick slice image, which is three times the slice thickness of the thin slice image. In this case, the display control function 152 controls the display 120 to display a thick slice image corresponding to three times the slice thickness of the thin slice image as a fourth display image. In a next instruction, thick slice images are displayed on the display 120 as fifth and sixth display images. In this way, the display control function 152 controls the display 120 to display the thick slice images constituting the second three-dimensional medical image.

In the example illustrated in FIG. 11A, assume that the control function 151 receives an instruction to move the display position from the position of the thick slice image being displayed on the display 120 by twice or more the slice thickness of the thick slice image. In this case, the control function 151 generates a slab image corresponding to twice the slice thickness of the thick slice image and based on a group of two adjacent thick slice images corresponding to the amount of movement. At this time, the display control function 152 controls the display 120 to display, as a seventh display image, the slab image generated by the control function 151. In a next instruction, a slab image is displayed on the display 120 as an eighth display image. In this way, the display control function 152 controls the display 120 to display a slab image based on the thick slice image constituting the second three-dimensional medical image.

In the example illustrated in FIG. 11B, the display control function 152 first controls the display 120 to display a thin slice image having a slice thickness of 0.5 mm as first to third display images by moving a display position one by one. It is assumed that the control function 151 receives an instruction to move the display position from the position of the thin slice image being displayed on the display 120 by twice or more the slice thickness of the thick slice image. In this case, the control function 151 generates a slab image corresponding to twice the slice thickness of the thick slice image and based on a group of two adjacent thick slice images corresponding to the amount of movement. At this time, the display control function 152 controls the display 120 to display, as a fourth display image, the slab image generated by the control function 151. In a next instruction, the slab image is displayed on the display 120 as a fifth display image. In this way, the display control function 152 controls the display 120 to display a slab image based on the thick slice image constituting the second three-dimensional medical image.

In the processes in FIGS. 11A and 11B, the control function 151 may pre-generate slab images having a plurality of slab thicknesses for each thick slice image constituting the second three-dimensional medical image, and store the generated slab images in the storage circuitry 140. In this case, the display control function 152 controls the display 120 to display the generated slab images.

As described above, in the medical image processing apparatus 100 according to the third embodiment, when a user gives an instruction for ±m slice feeding and m is equal to or greater than the ratio a of a slice spacing of a thin slice and a slice spacing of a thick slice, a thick slice image is displayed on the display. Thus, when a user performs slice feeding more quickly than a certain degree, a thick slice image equivalent to a thin slice images is displayed on the display. Accordingly, in accordance with the medical image processing apparatus 100 according to the third embodiment, even when a user wants to quickly observe an entire three-dimensional medical image, information on all slice images included in the three-dimensional medical image is displayed on the display 120 to be able to assist the user in observing the three-dimensional medical image.

### Fourth Embodiment

The first to third embodiments have described a planar image display procedure for updating a display position on the basis of only user instructions. The fourth embodiment describes a planar image display procedure in consideration of a time interval at which two consecutive user instructions are input and image display update capability of the medical image processing apparatus 100 (time required to update image display once) in addition to user instructions. The following display procedure makes it possible to display slab images having smaller slab thicknesses at as many display positions as possible (that is, more times) within the range in which the image display update capability of the medical image processing apparatus 100 is allowed.

Since the configuration diagram of a medical image processing apparatus according to a fourth embodiment is the same as the configuration diagram in FIG. 1, a description thereof is omitted.

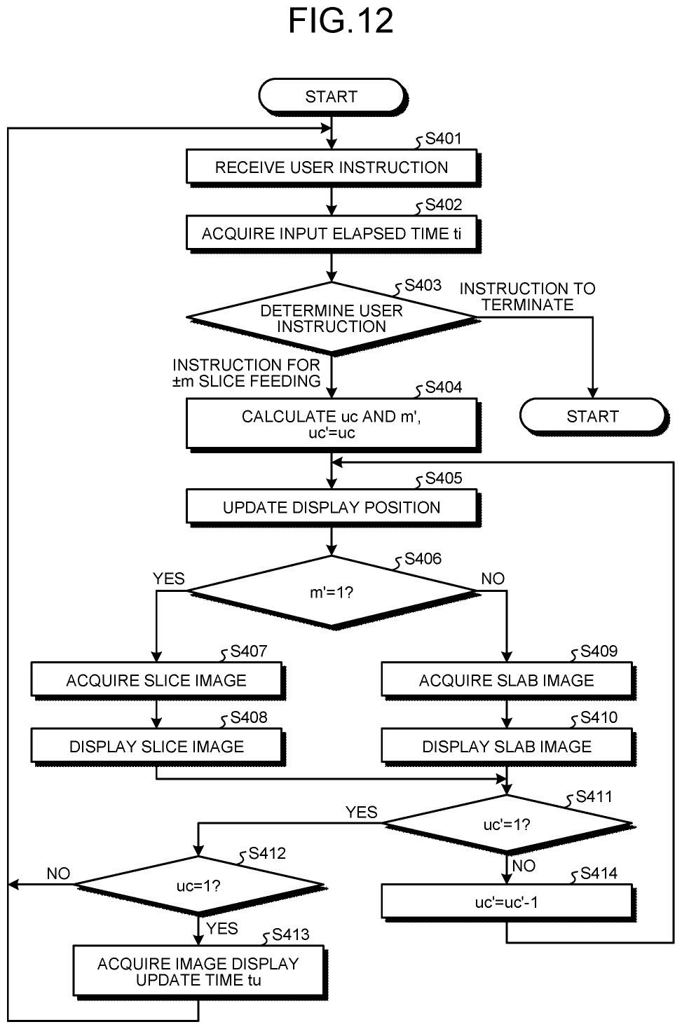

The fourth embodiment differs from the first to third embodiments in the procedure by which the processing circuitry 150 acquires a planar image and displays the planar image on the display 120. A detailed processing procedure of the processing circuitry 150 is described below with reference to a flowchart in FIG. 12.

FIG. 12 is a flowchart illustrating the procedure of a process performed by a medical image processing apparatus according to a fourth embodiment.

At step S401, the control function 151 receives the input of user instructions via the input interface 110.

At step S402, the control function 151 acquires a current time t0. When a previous time t0′ acquired when the previous step S402 was performed is stored in the storage circuitry 140, the control function 151 reads the time t0′ from the storage circuitry 140 and calculates an input elapsed time ti from Equation (1) below. The control function 151 stores the current time t0 in the storage circuitry 140 as t0′. When the input elapsed time ti can be calculated, the control function 151 stores the input elapsed time ti in the storage circuitry 140.

$$ti = t 0 - t 0 ' \qquad ( 1 )$$

The control function 151 may store ti calculated each time step S402 is performed as ti1, ti2, . . . , tix (x is a natural number). After tix is stored up to a predetermined number, the input elapsed time ti may be acquired by calculating an average value of the plurality of tix or by acquiring a representative value such as a minimum value, and may be stored in the storage circuitry 140.

The input elapsed time ti described above is a time interval at which two consecutive user instructions are input. In order to complete the procedure in FIG. 12 between the input of a certain user instruction and the input of a next user instruction, the time interval at which the two consecutive user instructions are input is acquired.

At step S403, the control function 151 determines a next process to be performed according to a user instruction. When the user instruction is an instruction for ±m slice feeding (m is a natural number), the procedure in FIG. 12 proceeds to step S404, and when the user instruction is an instruction to terminate the procedure, the procedure in FIG. 12 ends.

An input form of the instruction for ±m slice feeding can employ various forms described in the first embodiment. For example, as illustrated in FIG. 4A, a user can instruct the amount of movement of slice feeding by performing an operation (click and drag operation) of moving the mouse while clicking the button of the mouse that is the input interface 110.

At step S404, the display control function 152 calculates the number uc of display position updates (uc is an integer) from Equation (2) below when an image display update time tu to be described below is read from the storage circuitry 140.

$$u c = ti \div tu - b \qquad ( 2 )$$

In Equation (2) above, the display control function 152 takes, as “uc”, the value of “ti÷tu−b” rounded down to the decimal point.

On the other hand, when the display control function 152 fails to read the image display update time tu to be described below from the storage circuitry 140, the display control function 152 puts 1 into uc. The number uc of updates is the number of times the image display can be updated during the input elapsed time ti. The input elapsed time ti, the number uc of updates, and the image display update time tu to be described below are examples of indicators related to the image display update of the apparatus.

In Equation (2) above, b is a constant with a predetermined value equal to or greater than 0, and is usually set to 0. A larger value for the constant b results in a smaller value for the number uc of display position updates and a larger value for m′ to be described below. That is, when the constant b is set to a large value, the number of times the display position is automatically updated for one-time user instruction is reduced, and the slab thickness of a slab image displayed on the display 120 increases.

The display control function 152 puts the value “1” into uc when the calculation result of Equation (2) above is 0 or negative, and puts the value “m” into uc when the calculation result of Equation (2) above exceeds the absolute value m of the amount of slice movement in the instruction for ±m slice feeding. That is, uc is a natural number equal to or less than m.

The display control function 152 further calculates the number m′ of slice images (m′ is an integer) used to generate a slab image from Equation (3) below. In Equation (3) below, the display control function 152 takes, as “m′”, the value of “m÷uc” rounded down to the decimal point.

m′=m÷uc (3)

According to Equation (3) above, when uc is 1, one slab image based on m slice images (m is the absolute value of the amount of slice movement) is used for image display, and when uc is m, each of the m slice images is used for image display. On the other hand, when uc is 2 or more and smaller than m, m′ is smaller than m, and a slab image based on m′ slice images is acquired a plurality of times for image display, m′ being smaller than m indicating the absolute value of the amount of slice movement smaller than a user instruction. That is, when uc is 2 or more and smaller than m, a slab image having a slab thickness smaller than the slab thickness based on the amount of movement instructed by a user can be displayed.

The display control function 152 puts uc into a variable uc′. Subsequently, the display control function 152 stores each of uc, m′, and uc′ in the storage circuitry 140.

In this way, the display control function 152 determines the number m′ of slice images to be used for image display on the basis of the frequency with which a user instructs to move a display position and the indicators (the input elapsed time ti, the number uc of updates, and the image display update time tu to be described below) regarding the image display update of the apparatus.

The image display update time tu to be described below is the time required to update once image display determined by the image display update capability of the medical image processing apparatus 100. Since processes from step S405 to S414 to be described below need to be completed within the time required to update the image display once, the number uc of display position updates is determined in the manner described above in order to guarantee the completion.

At step S405, the display control function 152 moves the display position of the planar image displayed on the display 120 by +m′ or −m′ in the direction (+ direction or − direction) of slice movement in the instruction for ±m slice feeding.

At step S406, the display control function 152 determines whether the number m′ of slice images to be reflected in the slab image is 1, and determines a next process to be performed according to the result of the determination. When the number m′ of slice images to be reflected in the slab image is 1, the procedure in FIG. 12 proceeds to step S407, and when m′ is 2 or more, the procedure in FIG. 12 proceeds to step S409.

At step S407, the display control function 152 reads a slice image located at the display position updated at step S405 from the storage circuitry 140.

At step S408, the display control function 152 displays the read slice image on the display 120.

At step S409, the display control function 152 acquires, from the storage circuitry 140, a slab image (having a slab thickness) located at the display position updated at step S405 and generated based on the m′ slice images.

At step S410, the display control function 152 displays the acquired slab image on the display 120.

At step S411, the display control function 152 reads the variable uc′ from the storage circuitry 140, determines whether the variable uc′ is 1, and determines a next process to be performed according to the result of the determination. When the variable uc′ is 1, the procedure in FIG. 12 proceeds to step S412, and when the variable uc′ is 2 or more, the procedure in FIG. 12 proceeds to step S404.

At step S412, the display control function 152 reads the number uc of updates from the storage circuitry 140, determines whether the number uc of updates is 1, and determines a next process to be performed according to the result of the determination. When the number uc of updates is 1, the procedure in FIG. 12 proceeds to step S413, and when the number uc of updates is 2 or more, the procedure in FIG. 12 returns to step S401.

At step S413, the display control function 152 acquires the current time t1. The control function 151 reads time t0′ from the storage circuitry 140 and calculates the image display update time tu from Equation (4) below. The control function 151 stores the image display update time tu in the storage circuitry 140. Subsequently, the procedure in FIG. 12 returns to step S401.

tu=t1−t0′ (4)

The control function 151 may separately store, as tu1, tu2, . . . , tux (x is a natural number), the image display update time tu calculated each time step S413 is performed. After tux is stored up to a predetermined number, the image display update time tu may be acquired by calculating an average value of the plurality of tux or by acquiring a representative value such as a maximum value, and may be stored in the storage circuitry 140.

At step S414, the display control function 152 reduces the value of the variable uc′ by 1. Subsequently, the procedure in FIG. 12 returns to step S405.

Each time the processes from steps S405 to S411 described above are repeated, the display position moves by m′. Subsequently, a slab image generated from the m′ slice images is displayed at each moved display position on the display 120.

As described above, the medical image processing apparatus 100 according to the fourth embodiment performs the following control when a user gives an instruction for ±m slice feeding. That is, a slab image having a predetermined slab thickness is repeatedly displayed on the display 120 while moving a display position a number of times determined based on a user instruction, the input elapsed time ti, and the image display update time tu. Thus, even when a user quickly performs slice feeding, a slab image including information on slice images having a number corresponding to the amount of movement of the display position is displayed on the display 120 while automatically moving the display position as many times as possible. Accordingly, in accordance with the medical image processing apparatus 100 according to the present embodiment, even when a user wants to quickly observe an entire three-dimensional medical image, information on all slice images included in the three-dimensional medical image is displayed on the display 120 to be able to assist the user in observing the three-dimensional medical image.

As an application example of the fourth embodiment, the display control function 152 may determine whether to display a slice image as a first image or a slab image as a second image depending on the status of a display position movement instruction that is waiting to be performed. In such a case, when determining to display the slab image, the display control function 152 determines the number m′ of slice images to be reflected in the slab image.

Specifically, assume a situation where a user has given an instruction to move the display position of, for example, five slice images, such as +1 slice feeding or −1 slice feeding, but the display position movement instruction is waiting to be performed by the processing capacity of a processor such as a CPU. In this case, the display control function 152 confirms the situation where the display position movement instruction for the five slice images is waiting to be performed by the processing capacity of the processor, acquires a slab image based on a group of five adjacent slice images from the storage circuitry 140 and controls the display 120 to display the acquired slab image. Alternatively, the control function 151 may generate a slab image in real time and the display control function 152 may control the display 120 to display the generated slab image.

That is, in the application example of the fourth embodiment, even when a user inputs an instruction for ±1 slice feeding, but a display process is not completed in time, resulting in the input of an instruction for ±n slice feeding, a slab thickness can be adaptively determined and a slab image can be displayed. According to the application example of the fourth embodiment described above, for example, as illustrated in FIG. 6E, the display control function 152 can sequentially display slab images with slab thicknesses adaptively changed to 3, 5, and 7, depending on the status of the display position movement instruction that is waiting to be performed.

Each component of each apparatus illustrated in the present embodiment is functionally conceptual, and does not necessarily have to be physically configured as illustrated in the drawings. That is, the specific form of distribution or integration of each apparatus is not limited to those illustrated in the drawings, but can be configured by functionally or physically distributing or integrating all or part thereof in arbitrary units, depending on various loads, use conditions, and the like. Moreover, each processing function performed by each device can be implemented in whole or in part by a CPU and a computer program that is analyzed and executed by the CPU, or by hardware using wired logic.

The method described in the present embodiment can be implemented by executing a computer program prepared in advance on a computer such as a personal computer or a workstation. The computer program can be distributed via a network such as the Internet. The computer program can also be recorded on a non-transitory computer readable recording medium such as a hard disk, a flexible disk (FD), a CD-ROM, an MO, and a DVD, and can be executed by being read from the recording medium by a computer.

According to at least one embodiment described above, observation of medical images can be assisted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing apparatus comprising processing circuitry configured to
receive an instruction to move a slice position when a three-dimensional medical image including a plurality of slice images of a subject is displayed, and
control a display to display a slice image at a destination slice position as a first image when the received instruction is an instruction to move the slice position by less than a predetermined interval, and to control the display to display a second image reflecting information on a plurality of slice images including the slice image at the destination slice position when the received instruction is an instruction to move the slice position by more than the predetermined interval.

2. The medical image processing apparatus according to claim 1, wherein the second image is a slab image based on a group of slice images including adjacent slice images having a number corresponding to an amount of movement determined by the received instruction and including a slice image at a destination position determined by the amount of movement.

3. The medical image processing apparatus according to claim 2, wherein the group of slice images from which the slab image is derived includes slice images between the slice image at the destination position and a slice image at a pre-movement position.

4. The medical image processing apparatus according to claim 1, wherein the processing circuitry
generates slab images including the slice image and having a plurality of different slab thicknesses with respect to each slice image constituting the three-dimensional medical image, stores a group of the generated slab images in a storage circuitry, and
acquires a slab image to be subsequently displayed, corresponding to the second image, from the group of the slab images stored in the storage circuitry, and controls the display to display the acquired slab image.

5. The medical image processing apparatus according to claim 1, wherein the processing circuitry
generates a slab image from a plurality of slice images, and
generates a slab image to be subsequently displayed, corresponding to the second image, and controls the display to display the generated slab image.

6. The medical image processing apparatus according to claim 2, wherein, in a state in which the slab image is displayed on the display, when no instruction to move the slice image is received for a predetermined time, the processing circuitry controls the display to display a slice image located at a destination position within the group of the slice images from which the slab images are derived.

7. The medical image processing apparatus according to claim 6, wherein, in a period in which no instruction to move the slice image is received after the slab image is displayed on the display, the processing circuitry controls a slab thickness of a slab image displayed as the second image to be reduced over time in a state of including the slice image at the destination position.

8. The medical image processing apparatus according to claim 2, wherein the processing circuitry controls the display to display, as the second image, the slab image in which the slice image at the destination position determined by the amount of movement serves as a slab center.

9. The medical image processing apparatus according to claim 1, wherein
when an instruction to continuously move the slice position by the predetermined interval or more is received,
the processing circuitry controls the second image to be sequentially displayed according to the destination slice position.

10. The medical image processing apparatus according to claim 1, wherein
when a storage circuitry stores a second three-dimensional medical image to be compared with a first three-dimensional medical image that is the three-dimensional medical image,
upon displaying the first three-dimensional medical image, the processing circuitry displays the second three-dimensional medical image in conjunction with the first three-dimensional medical image.

11. The medical image processing apparatus according to claim 10, wherein the second three-dimensional medical image is a past three-dimensional medical image to be compared with the first three-dimensional medical image or a three-dimensional processed image generated by using the first three-dimensional medical image.

12. The medical image processing apparatus according to claim 1, wherein
when a storage circuitry stores a second three-dimensional medical image of the subject taken including a captured part of a first three-dimensional medical image that is the three-dimensional medical image, the second three-dimensional medical image including a slice image having a slice thickness greater than a slice thickness of a slice image constituting the first three-dimensional medical image,
the processing circuitry controls the display to display a slice image constituting the second three-dimensional medical image as the second image when an instruction to move the slice position by the predetermined interval or more is received.

13. The medical image processing apparatus according to claim 1, wherein, on the basis of a frequency with which a user instructs to move a slice position and an indicator regarding an image display update of the apparatus, the processing circuitry determines the number of slice images to be used for image display.

14. The medical image processing apparatus according to claim 1, wherein the processing circuitry determines whether to display the first image or the second image depending on a status of a slice position movement instruction that is waiting to be performed, and determines the number of slice images to be reflected in the second image when determining to display the second image.

15. The medical image processing apparatus according to claim 2, wherein the processing circuitry determines the amount of movement by a fixed value input by a user.

16. The medical image processing apparatus according to claim 2, wherein the slab image is generated from the group of the slice images by a maximum intensity projection method, a minimum intensity projection method, or a statistical process.

17. A medical image processing method comprising:
receiving an instruction to move a slice position when a three-dimensional medical image including a plurality of slice images of a subject is displayed;
controlling a display to display a slice image at a destination slice position as a first image when the received instruction is an instruction to move the slice position by less than a predetermined interval; and
controlling the display to display a second image reflecting information on a plurality of slice images including the slice image at the destination slice position when the received instruction is an instruction to move the slice position by more than the predetermined interval.

18. A non-transitory computer readable medium comprising instructions that cause a computer to execute:
receiving an instruction to move a slice position when a three-dimensional medical image including a plurality of slice images of a subject is displayed;
controlling a display to display a slice image at a destination slice position as a first image when the received instruction is an instruction to move the slice position by less than a predetermined interval; and
controlling the display to display a second image reflecting information on a plurality of slice images including the slice image at the destination slice position when the received instruction is an instruction to move the slice position by more than the predetermined interval.
